(19) United States
(12) Patent Application Publication
(10) Pub. No.: US 2024/0229185 A1
(43) Pub. Date: Jul. 11, 2024

(54) Device and Method for Thermal Treatment of a Metal Strip

(71) Applicant: ANDRITZ Technology and Asset Management GmbH, Graz (AT)

(72) Inventors: Martin Hamman, Palaiseau (FR); Jürgen Ziemendorff, Samoreau (FR)

(21) Appl. No.: 18/562,550

(22) PCT Filed: Mar. 2, 2022
(86) PCT No.: PCT/EP2022/055269

§ 371 Date: Nov. 20, 2023

(30) Foreign Application Priority Data
May 27, 2021 (AT) A50422/2021

(51) Int. Cl. C21D 9/56; C21D 1/767; C21D 9/573

(52) U.S. Cl. CPC C21D 9/563; C21D 1/767; C21D 9/561; C21D 9/573

(57) ABSTRACT

A heat treatment plant for continuous heat treatment of a metal strip has an annealing furnace and a subsequent over-ageing chamber that can be heated. In this plant, the metal strip is guided over several deflector rolls spaced vertically apart in the over-ageing chamber so that it passes through the over-ageing chamber in a meandering path. At least one deflector roll can be moved in vertical direction so that the strip length and the retention time of the metal strip in the over-ageing chamber can be set. A method for heat-treating a metal strip is also disclosed.

### BACKGROUND

The disclosed embodiments relate to a heat treatment plant for continuous heat treatment of a metal strip, with an annealing furnace and a subsequent, heatable over-ageing chamber. Here, the metal strip is guided into the over-ageing chamber over several rolls spaced vertically apart from one another so that it passes through the over-ageing chamber in a meandering path.

Conventional strip treatment plants consist of several chambers in which the metal strip is heated first of all to the annealing temperature and maintained at this temperature for a certain period of time. It is also possible to follow a defined temperature curve. Annealing furnaces of this kind are sufficiently well known. The metal strip is subsequently cooled down at a predefined cooling rate, brought to a defined over-ageing temperature and maintained at this temperature for a predefined period of time. Thus, so-called over-ageing chambers are used to hold a metal strip at a certain temperature (over-ageing temperature) for a precisely defined period of time. These chambers are often referred to as “holding chambers”, “soaking chambers”, or “partitioning chambers”. The temperature inside the over-ageing chamber should remain as constant as possible and, depending on the alloy of the metal strip, between 150° C. and 500° C. These over-ageing chambers normally have an inert gas or a reducing atmosphere, for example a mix of hydrogen and nitrogen. Subsequently, the metal strip can be cooled down to room temperature or brought to the coating temperature in galvanizing plants, for example, or in electrogalvanizing plants.

All of these heat treatment stages have an impact on the mechanical properties of the metal strip. It is not only important here to heat the metal strip to a certain temperature, but also to hold it at a defined temperature in the over-ageing chamber for a precisely defined period of time. Similarly, the heat-up and cool-down rates have an impact on the properties of the strip.

Furthermore, different thicknesses and compositions of metal strip require different heat treatment parameters.

The retention time of the metal strip in the over-ageing chamber is determined by the strip speed and the strip length in the over-ageing furnace. The length of the strip in conventional over-ageing chambers is predefined by the arrangement of the deflector rolls such that the retention time can only be controlled via the strip speed. However, the strip speed can only be varied to a very limited extent because, of course, each change in speed also has an impact on the production capacity, the heat-up rate and the cool-down rate.

DE 10 2015 001 438 A1 describes a system for heat treatment, through which the strip is guided in the form of loops. Thereby, the upper roller bridge can be moved vertically to adjust different belt throughput times.

US 2020/0131598 A1 describes a vertical looper, which can optionally also be heated and which is arranged between two annealing furnaces.

KR 101 951 945 B1 describes a vertical looper that can be arranged upstream or downstream of a furnace and has a device that prevents the strip from touching each other in the looper.

### SUMMARY

A strip treatment line is provided in which the retention time of the metal strip in the over-ageing chamber can be set in broader ranges so that completely different metal strips can be treated in the same strip treatment plant in which it is always possible to set the optimum retention time in the over-ageing chamber.

This is accomplished by an inventive strip treatment plant disclosed herein. Thus, at least one of the deflector rolls in the over-ageing plant can be moved in vertical direction, with the result that the length of the metal strip in the over-ageing chamber can be adjusted. Consequently, the retention time of the metal strip in the over-ageing chamber can also be adjusted.

This means that the retention time can be set independently of the strip speed by changing the strip length in the chamber. As a result, one and the same strip treatment plant can meet different production requirements and also be adjusted flexibly to new parameters.

According to the invention one or several movable deflector rolls are supported or secured in a certain position to which they have been moved to obtain a predefined strip length. The roll support is accommodated in a housing and can be run into the over-ageing chamber.

The deflector rolls remain in this defined position anyway during treatment of a specific metal strip. If they are supported or secured, this will relieve the load on the lifting mechanism for the deflector rolls.

Ideally, the strip speed for a predefined strip format (strip thickness, strip composition, strip width) and a predefined heat cycle (annealing temperature, cooling temperature, cooling rates . . . ) is set to provide maximum production capacity. The necessary strip length in the over-ageing chamber is set on the basis of this strip speed in order to obtain the optimum retention time, as required by the heat cycle, for the metal strip in the over-ageing chamber.

The over-ageing chamber described here must not be confused with a conventional looper. Loopers also have movable rolls and can accommodate different strip lengths. However, they are used to compensate for different strip speeds in the plant. If, for example, a strip newly inserted into the plant is welded to the end of the previous strip and the strip has to be halted in order to do this, the looper releases some of the stored strip so that the strip speed in the subsequent treatment plant does not change as a result. However, loopers of this kind are operated in ambient air at ambient temperature. They only serve to compensate for different strip speeds and do not perform heat treatment.

It is favourable if there are several deflector rolls that are movable in vertical direction in the disclosed over-ageing chamber. As a result, the strip length accommodated can be varied considerably.

Advantageously, one or several top deflector rolls can be moved in vertical direction.

The over-ageing chamber is heated preferably by electricity, for example by radiant tubes. However, the gas in the over-ageing chamber can also be removed by suction, heated electrically and then sprayed in again.

The disclosed over-ageing chamber can be disposed ahead of a coating plant, for example.

It is an advantage if there is a cooling section between the annealing furnace and the over-ageing chamber as a cooling stage of this kind is needed in many forms of heat treatment.

In addition to the device, also disclosed is a method for continuous heat treatment of a metal strip.

In this case, a retention time is defined for heat treatment of the metal strip in an over-ageing chamber and then the strip length and thus also the retention time are set by moving at least one deflector roll. The movable deflector roll or the movable deflector rolls are supported or secured in a certain position per roll support. The roll support is accommodated in a housing and can be run into the over-ageing chamber.

Here, it is favourable if the metal strip in the over-ageing chamber undergoes heat treatment in a hydrogen-nitrogen atmosphere.

### BRIEF DESCRIPTION OF THE DRAWINGS

In the following, several possible embodiments of the invention are described on the basis of drawings. In these drawings:

FIG. 1 shows a schematic diagram of an over-ageing chamber according to the state of the art.

FIG. 2 shows an embodiment example of an over-ageing chamber with a movable, top deflector roll;

FIG. 3 shows another embodiment example of an over-ageing chamber with a movable, bottom deflector roll;

FIG. 4 shows an example of an over-ageing chamber with several movable, top deflector rolls;

FIG. 5 shows a schematic view of a possible roll moving system;

FIG. 6 shows three different roll positions in an over-ageing chamber 11;

FIGS. 7 and 8 show an embodiment example of a roll moving system;

FIGS. 9 and 10 show a schematic view of the heating and cooling systems of the over-ageing chamber 11;

### DETAILED DESCRIPTION

Identical reference symbols in the individual figures refer to the same plant components in each case.

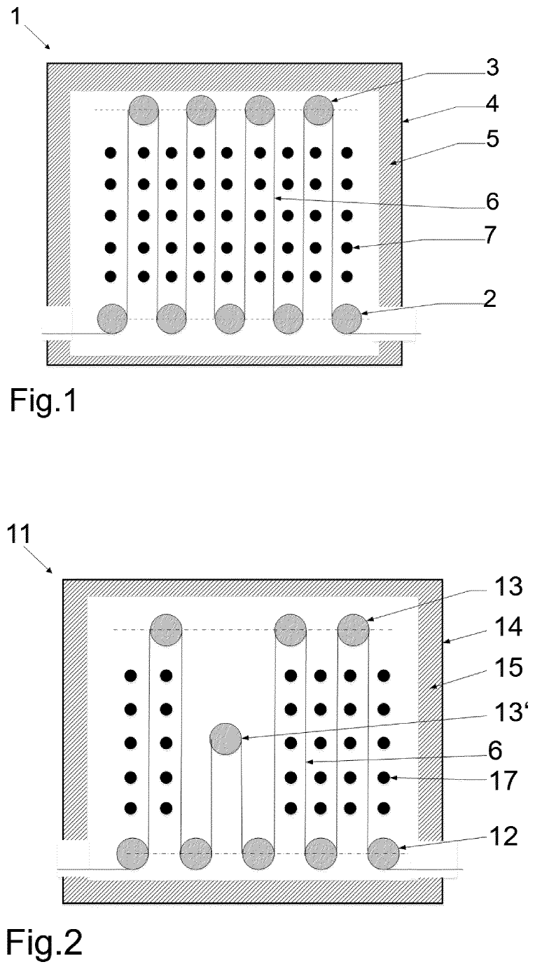

FIG. 1 shows an over-ageing chamber 1 according to the state of the art. Here, a metal strip 6 enters the over-ageing chamber 1 from the left and is deflected vertically upwards by a fixed, bottom deflector roll 2. In the upper part of the over-ageing chamber 1, the metal strip 6 is then deflected through 180° downwards by a fixed, top deflector roll 3. In this way, the metal strip 6 is guided on a meandering path through the over-ageing chamber 1 until it is finally deflected into a horizontal direction by the last, bottom deflector roll 2 and leaves the over-ageing chamber 1. The inside of the over-ageing chamber 1 is heated to a predefined temperature that is normally between 150° C. and 500° C. It is important to keep the inside of the over-ageing chamber 1 at as constant a temperature as possible. In order to reduce heat losses, the housing 4 of the over-ageing chamber 1 is insulated 5. The over-ageing chamber is heated by electrically heated radiant tubes 7.

In order to achieve optimum material properties, the metal strip 6 should spend a defined period of time (retention time) in the over-ageing chamber 1.

As the bottom and the top rolls 2, 3 in the over-ageing chamber according to FIG. 1 are fixed, the strip length accommodated is always the same. Thus, the retention time can only be changed by changing the strip speed.

FIG. 2 now shows an embodiment of the over-ageing chamber 11. The housing 14 here is also insulated 15 and there, too, the metal strip 6 is guided through the over-ageing chamber 11 on a meandering path over fixed, bottom deflector rolls 12 and fixed, top deflector rolls 13. However, a top deflector roll 13′ here can be moved in vertical direction (movable). In the present example, it has been run downwards to half the height. The over-ageing chamber in the present example is heated by electrically heated radiant tubes 17. In this case, these radiant tubes 17 are not disposed in the region of the movable deflector roll 13′ as this would hamper freedom of movement by the deflector roll 13′. Of course, it is also feasible to heat this over-ageing chamber 11 with a supply of hot gas, as is described further below.

As the deflector roll 13′ can now be moved in vertical direction, it can be used to change the length of the metal strip 6 in the over-ageing chamber 11. As a result, the retention time of the metal strip 6 in the over-ageing chamber 11 can be set without having to change the strip speed in order to do so.

The optimum retention time for a specific metal strip 6 is normally determined beforehand. With a certain predefined strip speed, the necessary strip length in the over-ageing chamber 11 is then calculated and set by moving the top deflector roll 13′ or the top deflector rolls 13′. The movable, top deflector rolls 13′ are preferably no longer moved but secured in position during treatment of a specific metal strip 6.

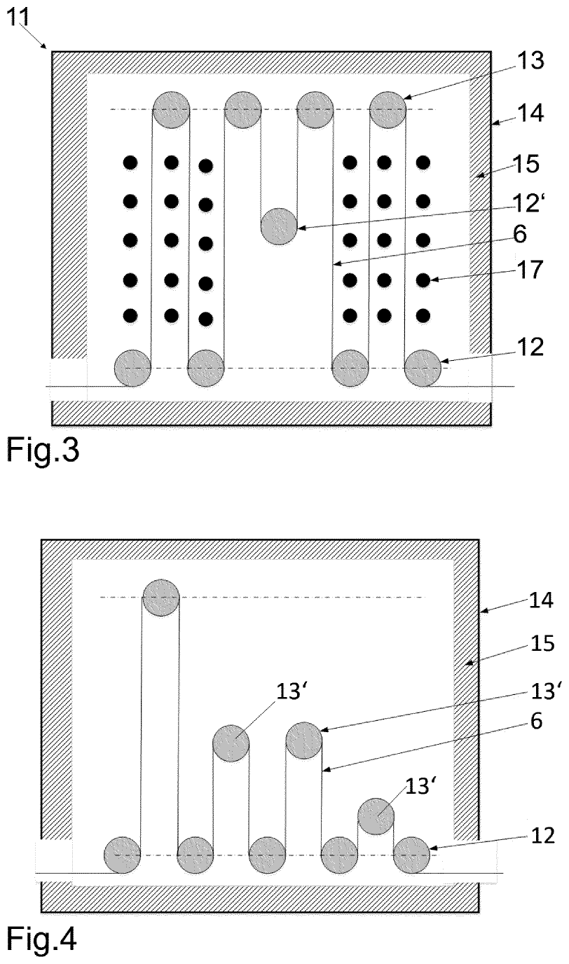

FIG. 3 shows an over-ageing chamber 11 in which a bottom deflector roll 12′ can be moved in vertical direction.

FIG. 4 shows an embodiment in which several top deflector rolls 13′ can be moved in vertical direction. Here, the top deflector rolls 13′ can be moved independently of one another.

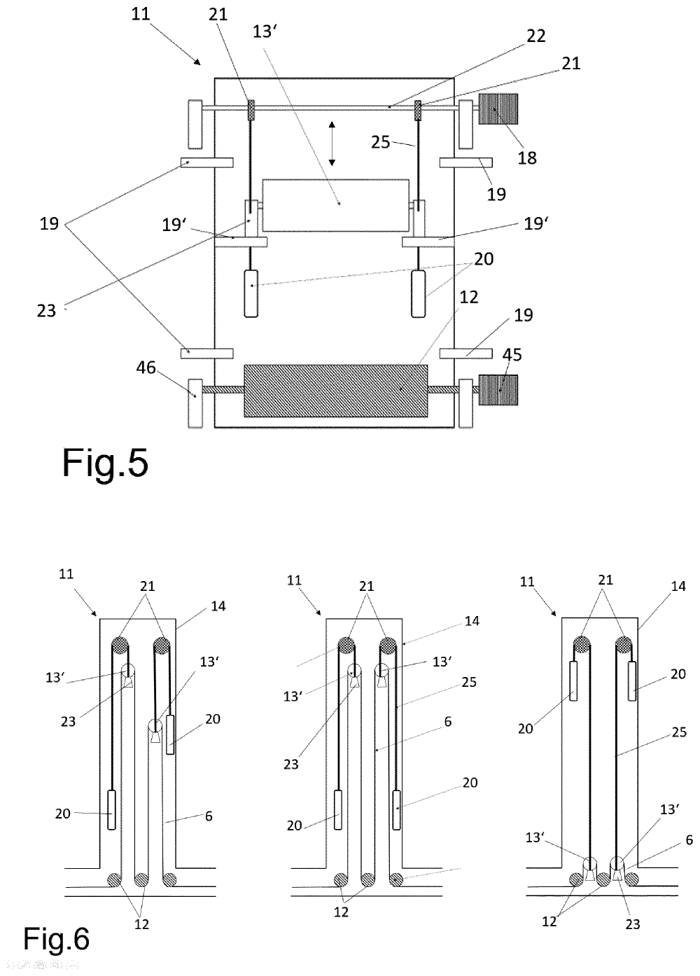

FIG. 5 shows a possible embodiment of a mechanism with which the deflector rolls 12′ or 13′ can be moved in vertical direction.

The bearing housing 23 of the top, movable deflector roll 13′ is attached to a chain 25 in each case, which is deflected over gear wheels 21 in the upper part of the over-ageing chamber 11. Counterweights 20 are attached to the other end of the chains 25. The two gear wheels 21 are linked to one another via a shaft 22 and connected to a drive 18. By rotating the shaft 22, the top deflector roll 13′ can be moved in vertical direction. The arrangement would be similar if it were to be used to move a bottom deflector roll 12′.

Roll supports 19, 19′ are provided at different heights here in the wall at the side. The deflector roll 13′ or 12′ can be placed on or secured to these roll supports. In this way, the load on the chains 25 and the drive 18 can be relieved during heat treatment of a specific metal strip 6. The fixed, bottom deflector roll 12 and the shaft 22 are supported outside the over-ageing chamber 11 here. Hence, these bearings 46 do not have to withstand high temperatures. The bottom deflector roll 12 has a drive 45.

FIG. 6 shows three different strip lengths in an over-ageing chamber 11.

In the middle illustration, the two top deflector rolls 13′ are in their topmost position, thus the strip length in the over-ageing chamber 11 is at its maximum and the retention time at a predefined strip speed is the longest.

In the left-hand illustration, one of the two movable, top deflector rolls 13′ has been lowered slightly, thus shortening the strip length and also the retention time at a predefined strip speed.

In the right-hand illustration, both the top deflector rolls 13′ are in their lowest position. Here, the strip length in the over-ageing chamber 11 is shortest, hence the retention time at a predefined strip speed is also minimized.

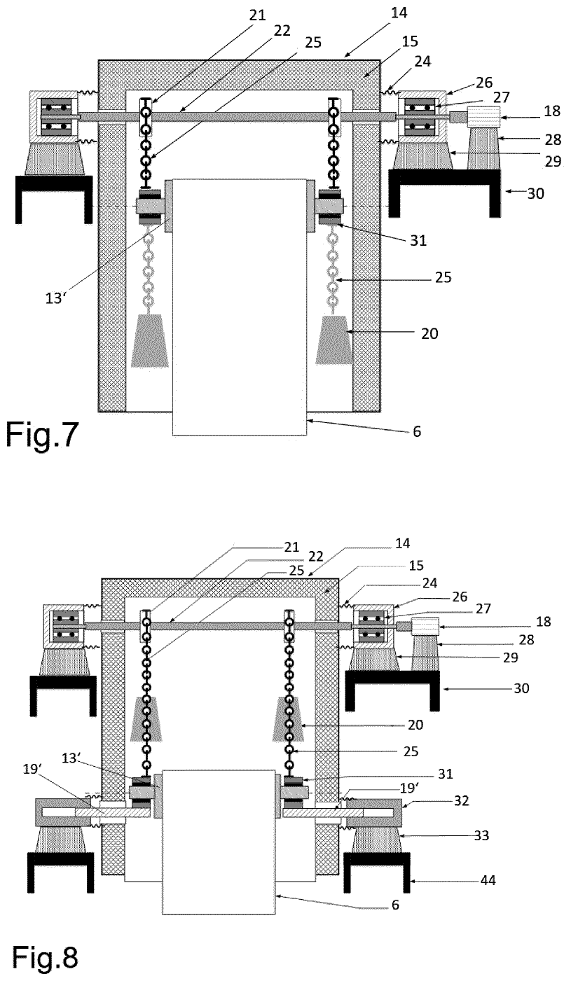

In FIGS. 7 and 8, the adjusting mechanism for the movable deflector rolls 12′ and 13′ is shown in more detail. As the deflector rolls 12′ and 13′ are inside the heated over-ageing chamber 11, where there can easily be temperatures of up to 500° C., they are supported on high-temperature bearings 31. An ordinary roller bearing 27 inside a bearing housing 26 is sufficient to support the shaft 22. The bearing housing 26 is connected to the supporting structure 30 via a bearing support 29. This structure 30 also supports the motor support 28 and the drive 18.

An expansion bellow 24 is disposed between the housing 14 of the over-ageing chamber 11 and the bearing housing 26 in order to be able to compensate better for any heat expansion and also as protection against dust.

FIG. 8 shows how the roll support 19, 19′ functions. The roll support 19, 19′ is accommodated in a housing 32 and can be run into the over-ageing chamber 11. Here, the housing 32 rests on a sub-structure 33 on a steel structure 44. Above the height of the chamber, there are generally several roll supports 19, 19′ at different heights so that the deflector roll 12′ or 13′ can be supported at different heights.

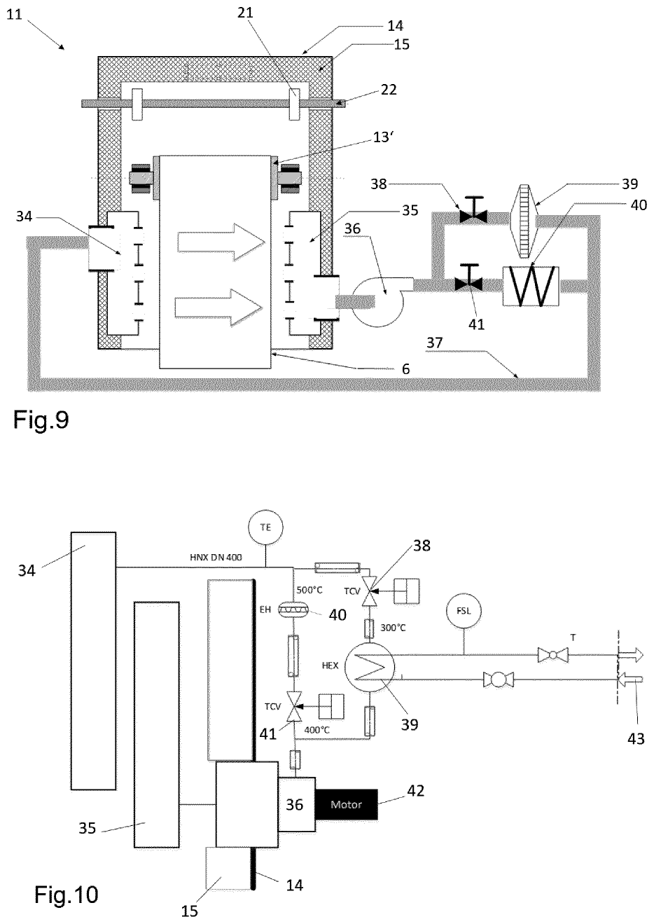

FIG. 9 shows a means of heating the over-ageing chamber 11. The inside of the over-ageing chamber 11 should have as constant a temperature as possible for treating a specific metal strip 6, and this temperature is between 150° C. and 500° C., depending on the material and treatment in question. As there are always heat losses, the chamber must be heated so that a temperature level that is as constant as possible can be maintained. Of course, there may be slight differences in temperature inside the over-ageing chamber 11, however this is normally only a few degrees Celsius. For heating purposes, hot gas, for example an inert or reducing gas like a nitrogen-hydrogen mix, is blown into the over-ageing chamber 11 through a feed box 34 disposed at the side and removed again by suction through a suction box 35 on the opposite side by a fan 36. Then the gas is either fed to an electric heating device 40 or a heat exchanger 39 and returned to the over-ageing chamber 11 through a recirculation pipe 37. The hot gas can be fed either to the heat exchanger 39 or electric heating device 40 through valves 38 and 41. The electric heating device 40 increases the gas temperature again. If the gas is fed through the heat exchanger 39, it can also be cooled. This is necessary, for example, when changing over from one steel grade to another. If, for example, the subsequent steel grade requires a lower over-ageing temperature, the gas is cooled in order to obtain the optimum temperature in the over-ageing chamber 11 as quickly as possible. At the same time, the strip length in the over-ageing chamber 11 can be adjusted by moving the deflector rolls 12′ and 13′ so that the subsequent steel grade undergoes optimum heat treatment.

FIG. 10 shows the heating and cooling device from FIG. 9 once again. It is evident here that cooling water 43 is supplied to the heat exchanger 39. The motor 42 for the fan 36 is also shown. In this illustration, a hydrogen-nitrogen (HNX) mix is used as heating medium.

### REFERENCE NUMERALS

1 Over-ageing chamber according to the state of the art
2 Bottom, fixed deflector roll
3 Top, fixed deflector roll
4 Housing
5 Insulation
6 Metal strip
7 Radiant tube
11 Over-ageing chamber
12 Bottom deflector roll (fixed)
12′ Bottom deflector roll (movable)
13 Top deflector roll (fixed)
13′ Top deflector roll (movable)
14 Housing
15 Insulation
17 Radiant tube
18 Drive
19 Roll support (run out)
19′ Roll support run into the over-ageing chamber 11
20 Counterweight
21 Gear wheel
22 Shaft
23 Bearing housing
24 Expansion bellow
25 Chain
26 Bearing housing
27 Roller bearing
28 Motor support
29 Bearing support
30 Supporting structure
31 High-temperature bearings
32 Housing for roll support 19
33 Substructure
34 Feed box
35 Suction box
36 Fan
37 Recirculation pipe
38 Valve
39 Heat exchanger
40 Electric heating device
41 Valve
42 Motor
43 Cooling water
44 Steel structure
45 Drive for the deflector roll 12
46 Bearing for the fixed deflector roll 12

1-13. (canceled)

14. A plant for continuous heat treatment of a metal strip (6), comprising:
an annealing furnace;
an over-ageing chamber (11) configured to be heated and positioned after the annealing furnace,
a plurality of deflector rolls for guiding the metal strip (6) positioned in the over-ageing chamber (11) vertically spaced apart from one another (12, 12′, 13, 13′) configured so that the metal strip (6) passes through the over-ageing chamber (11) in a meandering path, wherein
at least one of the deflector rolls (12′, 13′) can be moved in a vertical direction to alter a length of the metal strip (6) in the over-ageing chamber (11), thereby altering a time of retention of the metal strip (6) in the over-ageing chamber (11),
the at least one movable deflector roll (12′, 13′) is supported or secured in a particular position with a roll support (19, 19′) that is accommodated in a housing (32); and
the roll support (19, 19′) can be run into the over-ageing chamber (11).

15. The plant according to claim 14, comprising a plurality of movable deflector rolls (12′, 13′) that can be moved in a vertical direction.

16. The plant according to claim 15, comprising one or several top deflector rolls (13′) that can be moved in vertical direction.

17. The plant according to claim 14, comprising one or several top deflector rolls (13′) that can be moved in vertical direction.

18. The plant according to claim 14, wherein the over-ageing chamber (11) is heated electrically.

19. The plant according to claim 14, wherein the over-ageing chamber (11) is heated by delivering heated gas to the over-ageing chamber (11).

20. The plant according to claim 14, wherein the over-ageing chamber (11) is positioned ahead of a coating plant.

21. The plant according to claim 20, wherein the coating plant is an electrogalvanizing plant.

22. The plant according to claim 14, comprising a cooling section positioned between the annealing furnace and the over-ageing chamber (11).

23. The plant according to claim 15, comprising a cooling section positioned between the annealing furnace and the over-ageing chamber (11).

24. The plant according to claim 17, comprising a cooling section positioned between the annealing furnace and the over-ageing chamber (11).

25. A method for continuous heat treatment of a metal strip with an annealing furnace and a subsequent over-ageing chamber (11), comprising:
guiding the metal strip (6) in a meandering path over deflector rolls (12, 12′, 13, 13′) spaced vertically apart from one another in the over-ageing chamber (11),
moving at least one of the deflector roll (12′, 13′) in a vertical direction in the over-ageing chamber (11) to change a length of the metal strip (6) present in the over-ageing chamber (11), which thereby sets a retention time of the metal strip (6) for heat treatment in the over-ageing chamber (11), wherein
the at least one movable deflector roll (12′, 13′) is supported or secured in a position by a roll support (19′),
the roll support (19, 19′) is accommodated in a housing (32), and
the roll support (19, 19′) can be run into the over-ageing chamber (11).

26. The method according to claim 25, comprising:
removing gas in the over-ageing chamber (11) by suction;
heating the removed gas; and
feeding the heated gas back into the over-ageing chamber (11).

27. The method according to claim 26, wherein the gas is heated electrically.

28. The method according to claim 26, wherein the metal strip (6) in the over-ageing chamber (11) is heat-treated at a temperature within an approximate range of 150-500° C.

29. The method according to claim 28, wherein the metal strip (6) in the over-ageing chamber (11) is heat-treated at a temperature within an approximate range of 400-500° C.

30. The method according to claim 29, wherein the metal strip (6) in the over-ageing chamber (11) is heat-treated in a hydrogen-nitrogen atmosphere.

31. The method according to claim 26, wherein the metal strip (6) in the over-ageing chamber (11) is heat-treated in a hydrogen-nitrogen atmosphere.
